(19) United States
(12) Patent Application Publication
(10) Pub. No.: US 2004/0141150 A1
(43) Pub. Date: Jul. 22, 2004

(54) Hybrid multifocal contact lenses

(76) Inventors: Jeffrey H. Roffman, Jacksonville, FL (US); Ganesh N. Kumar, Ponte Vedra Beach, FL (US); Scott C. Durland, Jacksonville, FL (US); Ture Kindt-Larsen, Holte (DK); Timothy A. Poling, Jacksonville, FL (US); Edmund C. Rastrelli, Atlantic Beach, FL (US)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/348,448

(22) Filed: Jan. 21, 2003

(51) Int. Cl. G02C 7/02; G02C 7/10

(52) U.S. Cl. 351/164

(57) ABSTRACT

The invention provides a multifocal ophthalmic lens that is a hybrid lens in that it combines both soft lens material and rigid lens material. The lens is more comfortable to wear than a rigid lens and yet it provides correction for astigmatism without the need for the addition of cylinder power.

### FIELD OF THE INVENTION

The invention relates to multifocal ophthalmic lenses. In particular, the invention provides contact lenses that provide correction for presbyopia and corneal astigmatism by using both hard and soft materials in the contact lens.

### BACKGROUND OF THE INVENTION

As an individual ages, the eye is less able to accommodate, or bend the natural lens, to focus on objects that are relatively near to the observer. This condition is known as presbyopia. Similarly, for persons who have had their natural lens removed and an intraocular lens inserted as a replacement, the ability to accommodate is absent. Among the methods used to correct for the eye's failure to accommodate is the use of lenses that have more than one optical power. In particular, contact and intraocular lenses have been developed in which zones of distance, near, and intermediate power are provided.

Additionally, it is frequently necessary to combine cylinder correction for correction of astigmatism with multifocal correction in a lens. The addition of cylinder correction to a multifocal lens dramatically increases the number of stock keeping units (“SKUs”) that the lens manufacturer must produce. Cylinder correction also requires that the lens be maintained at a specific orientation while on the eye to be effective further complicating the design of the lens.

Contact lenses made from rigid materials provide correction for corneal astigmatism without the addition of cylinder power through formation of a tear layer between the lens and the corneal surface. Maintenance of orientation also is not an issue for lenses made from rigid materials because rigid lenses correct corneal astigmatism by creating a tear film between the lens' back surface and the corneal surface. Rigid lenses are disadvantageous in that they are less comfortable on-eye than lenses made from soft materials. However, soft contact lenses wrap around, or assume the shape of the corneal surface, providing inadequate correction for corneal astigmatism. Additionally, soft contact lenses require stabilization of the lens on-eye.

### BRIEF DESCRIPTION OF THE DRAWINGS

FIG. 1 depicts a magnified, cross-section view of a lens of the invention.

### DETAILED DESCRIPTION OF THE INVENTION AND PREFERRED EMBODIMENTS

The invention provides a multifocal ophthalmic lens, and methods for producing the lens, which lens both corrects the wearer's presbyopia and provides correction for astigmatism. The lens of the invention is a hybrid lens in that it combines both soft lens material and rigid lens material and is advantageous both in that it is more comfortable to wear than a rigid lens and it provides better correction for astigmatism than does a soft contact lens. Additionally, the lens can be manufactured using reduced SKUs to cover the range of refractive prescriptions because the rigid portion provides astigmatism correction without the need to add cylinder power to the lens.

In one embodiment, the invention provides an ophthalmic lens having: a.) a first element comprising a soft lens material having a convex surface and a concave surface, wherein one of the concave and convex surfaces comprises a multifocal optic zone; and b.) a second element comprising a hard lens material, wherein the second portion is wholly contained within the soft lens material. In another embodiment, the invention provides an ophthalmic lens having: a.) a first element comprising a soft lens material having a convex surface and a concave surface, wherein at least one of the concave and convex surfaces comprises a monofocal optic zone; and b.) a second element comprising a hard lens material having a convex and a concave surface, wherein one of the concave convex surfaces comprises a multifocal optic zone and wherein the second element is wholly contained within the soft lens material.

By “ophthalmic lens” is meant a contact lens, an intraocular lens, a corneal implant lens, an onlay lens, and the like, or combinations thereof. Preferably, the lenses of the invention are contact lenses. By “wholly contained within” is meant that the entirety of the hard lens material portion is encapsulated within the soft lens material and no surface of the hard lens material portion is exposed

The portion of the lens made of hard lens material may be made from any material suitable for forming ophthalmic lenses and capable of, when combined with the soft portion, neutralizing corneal astigmatism. Thus, the rigid portion must be sufficiently rigid so that the back surface of the lens resulting from the combination of the hard and soft lens material elements substantially does not conform to the shape of the corneal surface. Preferably, the hard lens material has a modulus of about 300,000 psi or greater. Additionally, the material must be compatible with the material used for the soft lens material portion of the lens, meaning that the hard lens material must not, when combined with the soft lens material, change the chemical characteristics of the soft lens material. Further, the soft lens material must bond to the rigid portion formed by the hard lens material. Thus, if the surface energy of the rigid portion is too low to allow for adequate bonding, the surface of the rigid portion may be treated to achieve the desired surface energy as, for example, by plasma or corona discharge treatment.

Hard lens materials for use in the invention are well known in the art. Illustrative materials include, without limitation, siloxane polymers, acrylates such as polymethylmethacrylate, cellulosic polymers, carbonates, silicone acrylates, fluoroacrylates, perfluorinated polyethers, alkyl substituted acetylenes, and the like, and copolymers thereof. Alternatively, the rigid portion may be made from a soft contact lens material having a modulus higher than that of the material used to form the lens in which the structure is embedded.

The rigid portion may be of any desirable shape, but preferably is substantially the same shape as that of the soft portion of the lens. More preferably, the rigid portion is substantially circular in shape and has a diameter of between about 10 and 8 mm. The thickness of the rigid portion will be about 12 to about 50 percent of the total thickness of the lens, which total lens thickness preferably will be about 0.100 to about 0.300 mm. The rigid portion may be manufactured by any known method including, without limitation, injection, coining, lathing, and cast molding and the like.

The material used for forming the soft portion of the lens must be a material that, when combined with the hard lens material, does not change the chemical characteristics of the hard lens material. Additionally, material shrinkage and expansion factors of the soft lens material must be such that delamination or separation of soft and rigid portions is prevented. Preferably, the soft lens material has an expansion of unity of 1 meaning that there is substantially less than about 1 percent shrinkage or expansion in the material in its fully hydrated state versus in its unhydrated, uncured state. One ordinarily skilled in the art will recognize that this may be achieved by formulating the lens material with a suitable diluent in a suitable amount to result in an expansion factor of 1. By way of example, if the water content of the soft lens material is 40 percent, then a diluent level of about 35 to about 45 percent will be used. It will also be recognized that the amount of diluent used will be selected based on the level of crosslinking and specific gravity of the diluent used. Suitable materials for manufacturing the soft lens material portion of the lens include, without limitation, 2-hydroxyethylmethacrylate and polymers and copolymers thereof, fluoropolymers, and the like. Preferably, the soft lens material has a modulus of about 30 to about 200 psi.

The lenses of the invention may be manufactured by any number of methods including, without limitation, embedding the hard lens material portion into the soft lens material, use of selective curing methods, grafting the hard lens material portion to a soft lens material and the like and combinations thereof. The structure may be introduced into the lens material by any convenient method. For example, the hard lens material portion may be first formed and then surrounded by lens material by inserting the structure into a contact lens mold half into which soft lens material is then dispensed, introducing the other mold half, and curing the mold assembly. As another example, soft lens material may be dispensed into a mold half and partially cured followed by insertion of the hard lens material portion onto the partially cured soft lens material, dispensing additional soft lens material, introducing the second mold half, and curing the mold assembly.

Preferably, cast molding is used and a portion of the uncured soft lens material is placed into the mold, followed by placement of the hard lens material portion, which portion has been previously molded or cast, into the mold. The soft lens material may then be partially cured before addition and curing of the remainder of the soft lens material. Alternatively, the remainder of the uncured soft lens material is placed in the mold and the soft lens material is cured. Curing of the soft lens material is carried out using conditions suitable for the material selected.

Placement of the hard lens material portion must be controlled so that is lies substantially in the optic zone of the lens. The hard lens material portion may be placed using any suitable method including, without limitation, a precision motor apparatus, a vacuum chuck and the like. Such apparatuses and chucks are commercially available.

At least one surface of the soft lens material portion of the lens, preferably the front surface, has a multifocal optical zone. The multifocal optical zone preferably provides alternating zones of distance vision and near vision power and more preferably, alternating zones of distance, near and intermediate power. By “distance vision power” and “near vision power” is meant that power necessary to correct the wearer's distance vision acuity and that power necessary to correct the wearer's near vision acuity, respectively. Intermediate power is power that is between the distance and near vision power. In a more preferred embodiment, 3 or more zones, and more preferably 3 to 5, of concentric annular zones that are spherical or aspherical are provided. The zones may be selected from any one of diffractive, birefringent, radially symmetric or asymmetric and the like and combinations thereof.

As yet another alternative, the multifocal zone may be a zone of progressive addition power, or a progressive addition power zone, meaning that at its innermost point the zone provides near vision power and as one moves radially outward to the periphery of the optic zone, the power continuously and progressively changes from near through intermediate vision power to distance vision power. As still another alternative, the multifocal zone may be a progressive zone that at its innermost point the zone provides distance vision power and as one moves radially outward to the periphery of the optic zone, the power continuously and progressively changes from distance through intermediate vision power to near vision power.

In embodiments in which the multifocal optic zone is on a surface of the soft lens material portion of the lens, the surfaces of the hard lens material portion are spherical or aspherical. If the refractive indices of the hard and soft lens materials differ, the addition of the hard lens material will introduce refractive power. Preferably, the hard and soft lens materials have substantially the same refractive indices or the difference in refractive indices between the materials is less than 0.5. Preferably, rigid has a substantially concave back surface, or surface nearest the eye, and the front surface is convex. Preferably, the rigid portion does not contribute to the visual acuity correction provided by the lens. Alternatively, at least one surface of the rigid portion of the lens has a multifocal optic zone. In this embodiment, the front and back surface of the soft portion are spherical or aspherical surfaces that preferably are monofocal surfaces.

In designing the lenses of the invention, any known methods for designing ophthalmic lenses may be used. For example, the lens may be modeled using multi-surface ray-tracing.

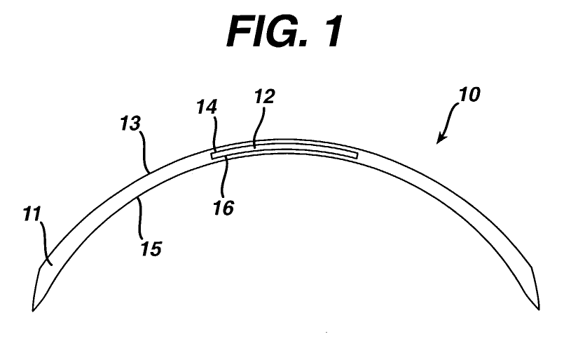

FIG. 1 depicts a magnified cross-section view of a lens 10 of the invention. Soft lens material portion 11 of lens 10 has hard lens material portion 12 within. Front surface 13 of the soft lens material portion is a multifocal surface. The front surface 14 and back surface 16 of the hard lens material are curved surfaces that are monofocal surfaces. Hard lens material 12 is sufficiently rigid so that, when lens 10 is worn on-eye, back surface 15 of the lens does not wrap around the cornea, but rather allows formation of a tear lens layer (not shown) between surface 15 and the corneal surface (not shown).

What is claimed is:

1. An ophthalmic lens, comprising: a.) a first element comprising a soft lens material having a convex surface and a concave surface, wherein one of the concave and convex surfaces comprises a multifocal optic zone; and b.) a second element comprising a hard lens material, wherein the second element is wholly contained within the soft lens material.

2. The lens of claim 1, wherein the lens is a contact lens.

3. The lens of claim 2, wherein the thickness of the contact lens is about 0.100 mm to about 0.300 mm and the second element has a thickness that is about 12 to about 50 percent of the total lens thickness.

4. The lens of claim 2, wherein the multifocal optic zone comprises concentric annular rings of alternating distance and near vision power.

5. The lens of claim 2, wherein the multifocal optic zone comprises concentric annular rings of alternating distance vision power, near vision power and intermediate power

6. The lens of claim 2, wherein the multifocal optic zone comprises a progressive addition power zone.

7. An ophthalmic lens having: a.) a first element comprising a soft lens material having a convex surface and a concave surface, wherein one of the concave and convex surfaces comprises a monofocal optic zone; and b.) a second element comprising a hard lens material having a convex and a concave surface, wherein one of the concave convex surfaces comprises a multifocal optic zone and wherein the second element is wholly contained within the soft lens material.

8. The lens of claim 7, wherein the lens is a contact lens.

9. The lens of claim 8, wherein the thickness of the contact lens is about 0.100 mm to about 0.300 mm and the second element has a thickness that is about 12 to about 50 percent of the total lens thickness.

10. The lens of claim 8, wherein the multifocal optic zone comprises concentric annular rings of alternating distance and near vision power.

11. The lens of claim 8, wherein the multifocal optic zone comprises concentric annular rings of alternating distance vision power, near vision power and intermediate power

12. The lens of claim 8, wherein the multifocal optic zone comprises a progressive zone.
